(19) United States
(12) Patent Application Publication
(10) Pub. No.: US 2009/0044866 A1
(43) Pub. Date: Feb. 19, 2009

(54) Auxiliary Fuel Pump

(75) Inventor: Edward Pearson, Autaugaville, AL (US)

Correspondence Address: BRADLEY ARANT ROSE & WHITE LLP, 200 CLINTON AVE. WEST, SUITE 900, HUNTSVILLE, AL, 35801, US

(73) Assignee: Crystal Lake Manufacturing, Inc., Autaugaville, AL (US)

(21) Appl. No.: 12/190,816

(22) Filed: Aug. 13, 2008

Related U.S. Application Data
(60) Provisional application No. 60/964,732, filed on Aug. 14, 2007.

(51) Int. Cl. G05D 11/00

(52) U.S. Cl. 137/87.01

(57) ABSTRACT

An auxiliary fuel pump is mounted external to a fuel tank within the body of a vehicle. The auxiliary fuel pump is connected to a transfer hose for transferring fuel from a fuel tank in the vehicle to another location.

This application claims the benefit of U.S. Provisional Patent application No. 60/964,732, filed on Aug. 14, 2007.

### BACKGROUND OF THE INVENTION

(a) Field of the Invention

The field of the present invention is the transfer of fuel from one vehicle to a separate device.

(b) Description of the Related Art

There are many devices which are used to transfer fuel from one vehicle to another device. One of the simplest concepts is a container, wherein the container is filled with fuel and transported in a vehicle to where the fuel is needed. The fuel can then be poured from the container into a pump, generator, motorcycle, tractor, or any other device which uses fuel. The container can tip and spill fuel, which presents a fire, health, and ecological hazard. Also, the container can breathe, with vaporous fuel exiting the container. This vaporous fuel presents a health hazard, as well as having a strong, unpleasant odor.

There have been fuel pumps mounted on a vehicle with a separate fuel transfer line. The fuel pump outlet is directed towards the fuel tank of the vehicle having the fuel pump, and the fuel pump inlet connects to a removable line. The removable line can then be inserted into a separate fuel container. This system is designed to fuel the vehicle to which the fuel pump is attached.

There have been descriptions of an auxiliary fuel pump mounted inside the fuel tank of a vehicle. A line connects the auxiliary pump to an auxiliary dispensing location. A separate line connects to the auxiliary dispensing location, and is used to transfer fuel from the vehicle housing the auxiliary pump to another devise.

Others have described a portable vehicle fueling devise which utilizes the primary vehicle fuel pump to transfer fuel to a separate devise. A “T” connection with a Schrader valve is in the line between the fuel pump and the engine, and a transfer line is connected to the Schrader valve to transfer fuel out of the vehicle to a separate device.

### BRIEF SUMMARY OF THE INVENTION

The current invention includes an auxiliary fuel pump located on the exterior of a fuel tank. A primary fuel pump can be utilized to transfer fuel to an engine of the vehicle. The auxiliary fuel pump is received within the body of the vehicle, and has an inlet port connected to the interior of the fuel tank. A discharge port of the auxiliary fuel pump is connected to a transfer line. The transfer line is stored within the body of the vehicle, and can be extended from a discharge gate located on the body of the vehicle.

### BRIEF DESCRIPTION OF THE SEVERAL VIEWS OF THE DRAWINGS

FIG. 1 is a schematic diagram of the fuel transfer system with an electric fuel pump.

FIG. 2 is a schematic diagram of the fuel transfer system with a manual fuel pump.

### DETAILED DESCRIPTION OF THE INVENTION

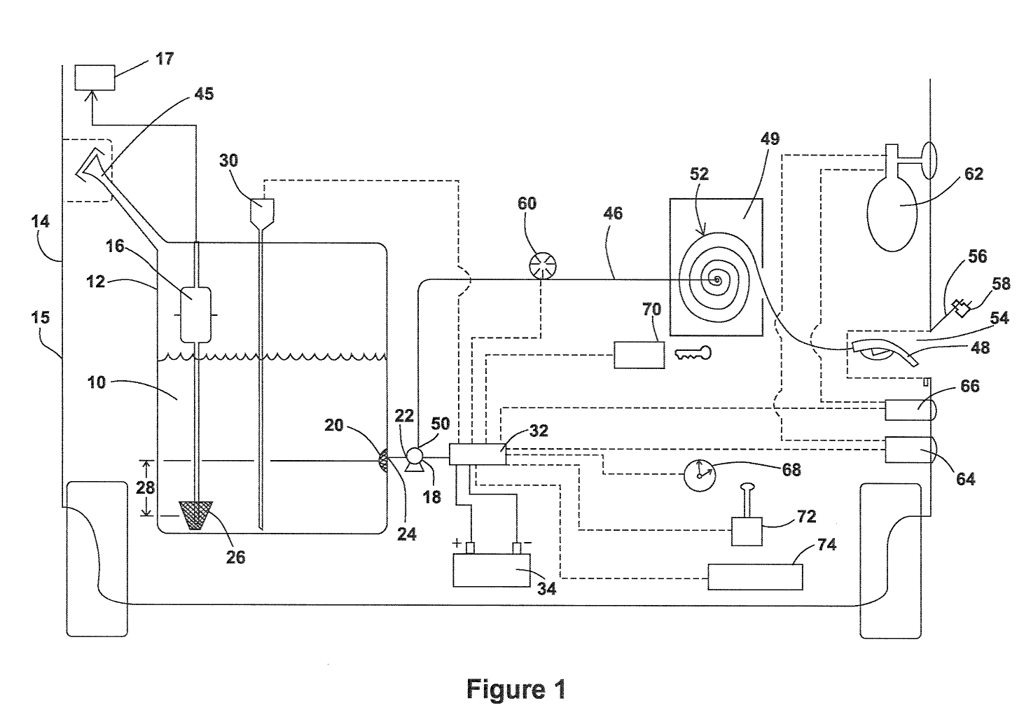

The present invention provides a safe, simple, clean and efficient method of transporting and transferring fuel, as shown in FIG. 1. Fuel 10 is stored in a primary fuel tank 12, which is part of a vehicle 14. The vehicle 14 has a body 15, and the components of the fuel transfer systems in this description are within the vehicle body 15 unless specifically stated otherwise. A primary fuel pump 16 may be present, where the primary fuel pump 16 transports fuel 10 from the primary fuel tank 12 to an engine 17 of the vehicle 14 so the primary fuel tank 12, the engine 17, and the primary fuel pump 16 are all in liquid communication. In some vehicles, the primary fuel pump 16 is located inside of the primary fuel tank 12, and in other vehicles the primary fuel pump is external to the primary fuel tank 12. It should be noted that some vehicles 14 have more than one fuel tank which supplies fuel 10 to the engine 17. In this discussion, a fuel tank is referred to as a primary fuel tank 12 if it is configured to supply fuel 10 to the engine 17 for powering the vehicle 14.

### Auxiliary Fuel Pump

The current invention includes an auxiliary fuel pump 18, which is mounted external to the fuel tank 12. The position of the auxiliary fuel pump 18 can vary, depending on the design of the vehicle 14 in which it is mounted. Operational and safety factors for each vehicle design will be factors considered in the location of the auxiliary fuel pump 18. Positioning the auxiliary fuel pump 18 exterior to the fuel tank 12 provides easier access for maintenance. Having the auxiliary fuel pump 18 exterior to the fuel tank 12 also provides greater flexibility for the type of pump used, such as manually, mechanically, or pneumatically operated pumps.

The auxiliary fuel pump 18 is separate and distinct from any pump or vacuum system used to transfer fuel 10 directly from the fuel tank 12 to the engine 17 of the vehicle 14. For safety reasons, the auxiliary fuel pump 18 can be a positive displacement pump. The auxiliary fuel pump 18 is in liquid communication with the interior of the fuel tank 12, so there is an outlet of the fuel tank 12 which is connected to the auxiliary fuel pump 18. This outlet is called the auxiliary outlet 24, because it is the outlet to the auxiliary fuel pump 18. There can be a screen 20 or filtering device of some sort between the interior of the fuel tank 12 and an inlet port 22 of the auxiliary fuel pump 18.

If the inlet port 22 of the auxiliary fuel pump 18 is connected to the primary fuel tank 12, as shown in FIG. 1, the system can be designed to prevent the auxiliary fuel pump 18 from draining the primary fuel tank 12, so the vehicle 14 will not be left out of fuel 10 and stranded. The auxiliary outlet 24 of the primary fuel tank 12 can be positioned higher than a primary outlet 26, wherein the primary outlet 26 supplies fuel 10 from the primary fuel tank 12 to the primary fuel pump 16. This creates a tank outlet height differential 28. This outlet height differential 28 provides for a quantity of fuel 10 available to the primary fuel pump 16 through the primary outlet 26 even if the auxiliary fuel pump 18 has drawn fuel 10 from the primary fuel tank 12 to the maximum extent possible. An alternate method to prevent draining of the primary fuel tank 12 includes utilizing an interlock for the auxiliary pump 18 based on a signal from a level indicator 30 for the fuel tank 12. Operation of the auxiliary pump 18 would be arrested when the level indicator 30 reached a predetermined point, wherein the predetermined point would be set to ensure there was still some fuel 10 left for the engine 17.

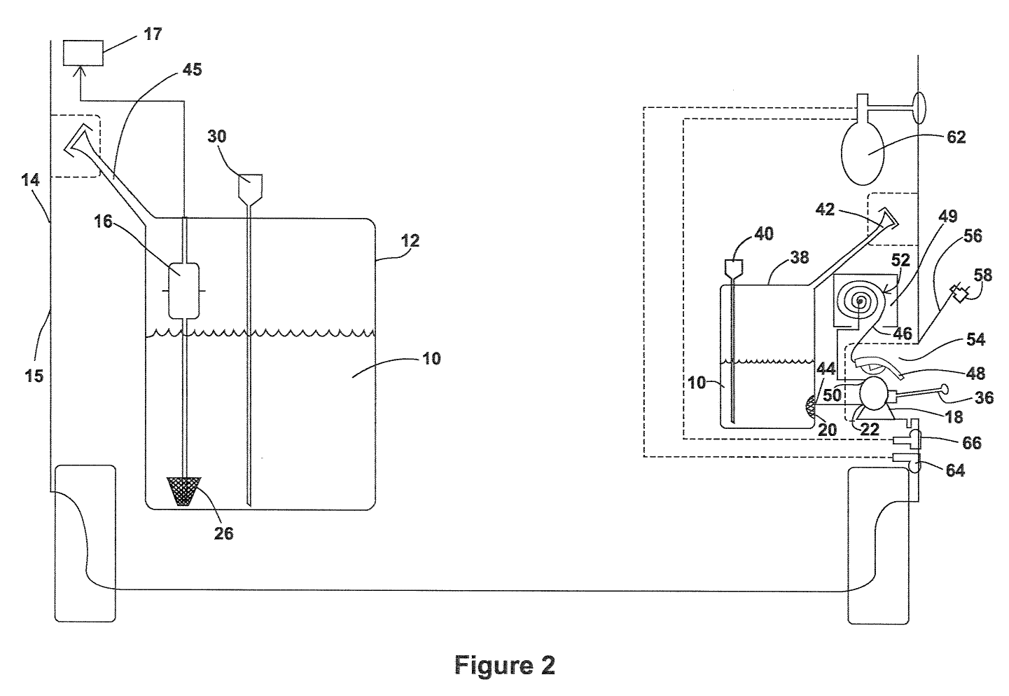

The auxiliary fuel pump 18 can be operated either manually or electrically. Other methods of operating the auxiliary fuel pump 18, such as pneumatics, could also be utilized. If an electric auxiliary fuel pump 18 is utilized, there can be a fuel pump controller 32 for controlling the pump operations. The fuel pump controller 32 would be connected to the auxiliary fuel pump 18. A battery 34 could be utilized to power the electric auxiliary fuel pump 18, including the use of the standard vehicle battery 34 used to start the engine 17 and power many devices on most vehicles 14. If a manual auxiliary fuel pump 18 is utilized, as shown in FIG. 2, a pump handle 36 can be utilized to power the pump. The pump handle 36 can be removable to facilitate storage when not in use.

### Auxiliary Fuel Tank

The current invention can include an auxiliary fuel tank 38. An auxiliary fuel tank 38 would not be directly connected to the engine 17 of the vehicle 14. The auxiliary fuel tank 38 could be equipped with an auxiliary level indicator 40, an auxiliary fill spout 42, and any other amenities desired. The size of the primary and auxiliary fuel tanks 12, 38 can vary, as desired. The position of the auxiliary fuel tank 38 would be within the body 15 of the vehicle, similar to the primary fuel tank 12, and factors such as safety and operational issues would be considered in the location and sizing of each fuel tank 12, 38.

Since the auxiliary fuel tank 38 is not connected to the engine 17 of the vehicle 14, a different type of fuel 10 could be stored in the auxiliary fuel tank 38. For example, the primary fuel tank 12 could store gasoline, and diesel fuel could be stored in the auxiliary fuel tank 38. Ethanol, kerosene, and other fuels could also be used. If an auxiliary fuel tank 38 were used, one could transfer fuel 10 from the auxiliary fuel tank 38 into the primary fuel tank 12, if desired. This could be done by pumping from the auxiliary fuel tank 38 into a container, and then transferring the contents of the container into the primary fuel tank 12, or by pumping directly from the auxiliary fuel tank 38 into the primary fuel tank fill spout 45. Other methods of transferring fuel between the two tanks 12, 38 may also be possible.

All aspects of the auxiliary fuel pump 18 described above could apply to the use of an auxiliary fuel tank 38. The auxiliary fuel pump 18 could still be electric or manual. It would be preferred if the auxiliary fuel tank outlet 44 were positioned close to the bottom of the auxiliary fuel tank 38 to utilize the full volume of the tank 38. There is no need to ensure a residual quantity of fuel 10 in the auxiliary fuel tank 38, because the fuel 10 for the engine 17 is stored separately, in the primary fuel tank 12.

### Transfer Hose and Transfer Gate

Referring to FIG. 1, a transfer hose 46 is used to transfer the fuel 10 from the fuel tank 12 to a nozzle 48 for discharge. When reference is made the fuel tank 12, it is to be understood the fuel tank 12 could be either the primary or auxiliary fuel tank 12, 38, depending on which tank the auxiliary fuel pump 18 is connected to. One end of the transfer hose 46 is connected to the auxiliary fuel pump discharge port 50, and the other end of the transfer hose is connected to the nozzle 48. The transfer hose 46 can be made of a flexible material rated for use with the fuel 10 stored in the fuel tank 12.

The transfer hose 46 is stored in a storage area 49 within the body 15 of the vehicle 14. The storage area 49 is large enough to hold the transfer hose 46 in the body 15 for transport. This prevents the transfer hose 46 from becoming lost, or from getting tangled in items external to the vehicle 14. A coiled spring reel 52 can be used to store the transfer hose 46 in the vehicle 14, where the coiled spring reel 52 is inside the storage area 49. This provides easy access to the transfer hose 46 when desired, and also provides for a compact, organized storage system for the transfer hose 46 when not in use. The coiled spring reel 52 can be constructed to lock when the transfer hose 46 is pulled out, and then to retract and re-coil the transfer hose 46 by slightly pulling on the hose to disengage the spring reel lock. The transfer hose 46 can also be loosely piled in the storage area 49, or other storage systems can be used.

The nozzle 48 is available in a compartment 54 behind a transfer gate 56. The transfer gate 56 can be a part of the vehicle body 15. The nozzle 48 should be approved for use with the fuel 10 in the fuel tank 12, and can be similar to the nozzles 48 commonly used in service stations. Smaller nozzle designs can also be used, so less space is needed for storage. The nozzle 48 can be secured in the compartment 54 in a variety of ways. For security reasons, the nozzle 48 can be protected by a lock 58 in the transfer gate 56. The position of the transfer gate 56 on the vehicle 14 can vary, depending on the design of the vehicle 14. If a manual auxiliary fuel pump 18 is used, access to the pump 18 for pumping the fuel 10 can be through the transfer gate 56, as seen in FIG. 2. If a pump handle 36 is used, it could be stored in the compartment 54 behind the transfer gate 56. More than one transfer gate 56 can be utilized, with the auxiliary fuel pump 18 accessed by one transfer gate 56, and the nozzle 48 accessed by another transfer gate 56. If a transfer gate 56 is used, at least a portion of the transfer hose 46 passes out of the vehicle body 15 by extending through the transfer gate 56 when one dispenses fuel 10. Therefore, a portion of the transfer hose 46 becomes external to the vehicle body 15 when in use.

A flow meter 60 can be connected to the transfer hose 46 to measure the fuel 10 discharged. The flow meter 60 could be electronic or mechanical, with the output read at a variety of locations, including the dashboard of the vehicle or within the compartment 54 for the nozzle 48.

### Safety

The storage, transport, and transfer of fuel 10 involve certain inherent hazards, based on the flammability and possible toxicity of the fuel used. A wide variety of safety devices can be incorporated into the current invention, with almost any combination possible. Most of the safety devices discussed below can be utilized independent of the use of other safety devices. The exact safety devices to be include on a particular vehicle 14 would depend on such factors as price, overall safety considerations, redundancy, vehicle configuration, consumer preferences, and many other factors.

When transferring fuel 10, a fire extinguisher should be readily available in case of emergency. The fire extinguisher available should be rated for flammable liquids and gas, such as fire class B in the United States. Halon fire extinguishers are one example of acceptable fire extinguishers. It is also possible to include an automatic fire suppression system 62, which can use Halon as a fire suppressant. Automatic discharge of other extinguishing materials can also be used. The automatic fire suppression system 62 is connected to the vehicle body 15, and can be positioned near the transfer gate 56. The transfer gate 56 should usually be close to the point were fuel is being transferred. The automatic fire suppression system 62 is activated by an automatic fire suppression system trigger. The automatic fire suppression system trigger can be a heat sensor 64, a smoke detector 66, or both, as well as other potential indicators of a fire. The automatic fire suppression system trigger is connected to the automatic fire suppression system, and can also be connected to the vehicle body 15 near the transfer gate 56.

Stopping or preventing fuel flow in unsafe conditions also improves the safety of the fuel transfer system. The use of interlocks with a fuel pump controller 32 to stop or prevent flow can be based on input from a wide variety of sources, where the source is connected to the fuel pump controller 32. Typically, triggering an interlock causes the fuel pump controller 32 to deactivate the auxiliary fuel pump 18, but interlocks can stop flow in other ways such as closing valves positioned in the transfer line 46. Interlocks can be mechanical, or electrical, or even programmed software. Some examples of sources include: a timer 68 to prevent extended fuel transfers, an interlock with the vehicle ignition 70, an interlock with a flow meter 60 to prevent flow beyond a predetermined volume, an interlock with a vehicle door lock system 72, an interlock with a vehicle security system 74, an interlock with an automatic transmission requiring the vehicle be in park to discharge fuel, an interlock with the primary fuel tank 12 level indicator 30, and interlocks with the automatic fire suppression system trigger.

Other interlocks are possible, including redundant use of the devices mentioned above, and other devices can be added to increase safety. Safety interlocks can also be utilized with manual auxiliary fuel pumps 18. The use of many standard fuel tank safety features, such as means for preventing fuel loss when a vehicle is upside down, can also be included on any fuel tank 12 described herein. Many references have been made to one device being connected to another device, but it is to be understood the connection can be an operative connection. An example of an operative connection includes radio connectivity without the use of physical wires.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. A fuel transfer apparatus comprising:
a vehicle having a body and a transfer gate in the body;
a primary fuel tank received within the vehicle, wherein the fuel tank includes a primary outlet and an auxiliary outlet, and the auxiliary outlet is positioned higher than the primary outlet;
a primary fuel pump connected to the primary outlet, where the primary fuel pump is in liquid communication and with an engine;
an auxiliary fuel pump positioned within the vehicle body exterior to the fuel tank, the auxiliary fuel pump having an inlet port and a discharge port, wherein the auxiliary fuel pump inlet port is connected to the auxiliary outlet;
a transfer hose connected to the fuel pump discharge port, the transfer hose stored within the body of the vehicle, wherein at least a portion of the transfer hose can be extended through the transfer gate;
a fuel pump controller connected to the auxiliary fuel pump, where the fuel pump controller activates and deactivates the auxiliary fuel pump, and where the controller includes interlocks such that the controller deactivates the auxiliary fuel pump when any interlock is triggered;
a timer connected to at least one of the interlocks such that the fuel pump will stop transferring fuel after a predetermined time interval;
a flow meter connected to the transfer hose;
an automatic fire suppression system connected to the vehicle body and positioned near the transfer gate;
a heat sensor connected to the vehicle body near the transfer gate, where the heat sensor is connected to the automatic fire suppression system such that the heat sensor can activate the automatic fire suppression system; and
a smoke detector connected to the vehicle body near the transfer gate, where the smoke detector is connected to the automatic fire suppression system such that the smoke detector can activate the automatic fire suppression system.

2. A fuel transfer apparatus comprising:
a vehicle having a body;
a fuel tank having an auxiliary outlet, where the fuel tank is within the vehicle body;
an auxiliary fuel pump positioned outside of the fuel tank, where the auxiliary fuel pump is connected to the auxiliary outlet; and
a transfer hose connected to the auxiliary fuel pump, where the transfer hose is stored within the vehicle body and where the transfer hose can be extended such that at least a portion of the transfer hose is outside of the vehicle body.

3. The fuel transfer apparatus of claim 2 where:
the fuel tank further comprises a primary outlet; and
the vehicle further comprises a primary fuel pump connected to the primary outlet, and the primary fuel pump is in liquid communication with a vehicle engine.

4. The fuel transfer apparatus of claim 3 where the auxiliary outlet is positioned higher than the primary outlet.

5. The fuel transfer apparatus of claim 2 where the fuel tank comprises a primary fuel tank and an auxiliary fuel tank, the vehicle further comprising a primary fuel pump in liquid communication with the primary fuel storage tank and a vehicle engine, and where the auxiliary fuel pump is in liquid communication with the auxiliary fuel tank.

6. The fuel transfer apparatus of claim 2 where the auxiliary fuel pump is an electric fuel pump.

7. The fuel transfer apparatus of claim 2 where the auxiliary fuel pump is a manually powered fuel pump.

8. The fuel transfer apparatus of claim 2 where the vehicle further comprises:
an automatic fire suppression system connected to the vehicle body;
a fire suppression system trigger operatively connected to the automatic fire suppression system, where the fire suppression system trigger can activate the automatic fire suppression system

9. The fuel transfer apparatus of claim 8 where the fire suppression system trigger includes a heat sensor.

10. The fuel transfer apparatus of claim 8 where the fire suppression system trigger includes a smoke detector.

11. The fuel transfer apparatus of claim 2 further comprising a fuel pump controller to active and deactivate the auxiliary fuel pump, where the fuel pump controller includes an interlock.

12. The fuel transfer apparatus of claim 11 where a vehicle ignition is connected to a fuel pump controller interlock.

13. The fuel transfer apparatus of claim 11 further comprising a flow meter connected to the transfer line, where the flow meter is connected to the fuel pump controller interlock.

14. The fuel transfer apparatus of claim 11 where the vehicle further comprises an automatic fire suppression system and a fire suppression system trigger, and the fire suppression system trigger is operatively connected to the automatic fire suppression system and the fire suppression system trigger is operatively connected to the fuel pump controller.

15. The fuel transfer apparatus of claim 11 further comprising a level indicator connected to the fuel tank, where the level indicator is operatively connected to the fuel pump controller interlock.

16. A vehicle comprising:
a body;
an engine within the body;
a fuel tank in liquid communication with the engine;
an auxiliary fuel pump external to the fuel tank and within the vehicle body, where the auxiliary fuel pump is in liquid communication with the fuel tank;
a flexible transfer hose, where the transfer hose is extendable beyond the vehicle body; and
a storage area within the vehicle body, where the storage area is large enough to receive the transfer hose.

17. The vehicle of claim 16 where the fuel pump is electrically powered.

18. The vehicle of claim 17 further comprising a fuel pump operatively connected to the auxiliary fuel pump.

19. The vehicle of claim 18 where the fuel pump controller includes an interlock, the vehicle further comprising an ignition switch connected to the fuel pump controller interlock.

20. The vehicle of claim 19 further comprising a level indicator operatively connected to the fuel tank, where the level indicator is connected to the fuel pump controller interlock.
